(19) United States
(12) Patent Application Publication
(10) Pub. No.: US 2013/0147232 A1
(43) Pub. Date: Jun. 13, 2013

(54) VEHICLE BODY AND MOLDING METHOD THEREOF

(71) Applicant: Byung Ha Min, Jeonju-si (KR)

(72) Inventor: Byung Ha Min, Jeonju-si (KR)

(73) Assignee: Hyundai Motor Company, Seoul (KR)

(21) Appl. No.: 13/557,726

(22) Filed: Jul. 25, 2012

(30) Foreign Application Priority Data
Dec. 8, 2011 (KR) 10-2011-0131230

(51) Int. Cl. B62D 29/04; B29C 43/10

(52) U.S. Cl. 296/181.2; 264/571

(57) ABSTRACT

A vehicle body includes a main body and a low body coupled to a lower portion of the main body, wherein the main body includes a main inner skin made of fiber reinforced plastic, a main core frame coupled to the main inner skin, a main reinforcing frame coupled to the main core frame, and a main outer skin coupled to the main reinforcing frame and made of fiber reinforced plastic, wherein the main inner skin, the main core frame, the main reinforcing frame, and the main outer skin of the main body are formed integrally by molding, and wherein a front surface, a back surface, a left side surface, a right side surface, and an upper surface of each of the main inner skin, the main core frame, the main reinforcing frame, and the main outer skin are formed integrally by molding.

### CROSS-REFERENCE TO RELATED APPLICATION

The present application claims priority of Korean Patent Application Number 10-2011-0131230 filed Dec. 8, 2011, the entire contents of which application is incorporated herein for all purposes by this reference.

### BACKGROUND OF INVENTION

1. Field of Invention

The present invention relates to a vehicle body and a molding method thereof, and more particularly to a vehicle body integrally molded without a frame and a molding method thereof.

2. Description of Related Art

Generally, a vehicle body includes a frame forming an outline of a vehicle, and panels coupled to the frame so as to form an exterior surface of the vehicle. The panels are separately coupled to each side of the frame. Therefore, the process of assembling the vehicle body becomes complex, and when each panel is coupled to the frame, steps can be formed between the frame and each panel

In addition, since the frame and each panel are respectively formed of a steel material, the vehicle body is heavy and strength of the vehicle body is relatively week.

Thus, in an effort to improve this, the vehicle body coupling a, upper body to a lower body without the frame has disclosed

Specifically, the upper body forming an upper surface of the vehicle body is integrally formed, but the side body is respectively formed at a front surface portion, a back surface portion, a left side surface portion, and a right side surface portion. The vehicle body is formed by assembling the above composition.

An assembling process of the vehicle body disclosed above is relatively simple, however, the upper body and the side body should be coupled by an additional process. Also, when the upper body is coupled to the lower body, steps can be formed between the upper body and the side body.

The above information disclosed in this Background section is only for enhancement of understanding of the background of the invention and therefore it may contain information that does not form the prior art that is already known in this country to a person of ordinary skill in the art.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a vehicle body and a molding method thereof having advantages of simplifying an assembly process and increasing strength of a vehicle body.

A vehicle body according to an exemplary embodiment of the present invention may include: a main body forming an appearance of a vehicle; and a low body forming a bottom surface and coupled to a lower portion of the main body, wherein the main body includes a main inner skin made of fiber reinforced plastic, a main core frame coupled to an exterior surface of the main inner skin, a main reinforcing frame coupled to an exterior surface of the main core frame, and a main outer skin coupled to an exterior surface of the main reinforcing frame and made of fiber reinforced plastic, wherein the main inner skin, the main core frame, the main reinforcing frame, and the main outer skin of the main body are formed integrally by molding, and wherein a front surface, a back surface, a left side surface, a right side surface, and an upper surface of each of the main inner skin, the main core frame, the main reinforcing frame, and the main outer skin are formed integrally by molding.

The main reinforcing frame may be made of a metal material.

The metal material may be aluminum or an aluminum alloy.

The main core frame may be formed by insert-molding a thermoplastic plastic to wood.

The lower body may includes a lower inner skin made of fiber reinforced plastic, a lower frame coupled to an exterior surface of the lower inner skin, and a lower outer skin coupled to an exterior surface of the lower frame and made of fiber reinforced plastic, wherein the lower inner skin, the lower frame, and the lower outer skin of the lower body are formed integrally by molding.

A main body forming an appearance of a vehicle according to another exemplary embodiment of the present invention may include: a main inner skin made of fiber reinforced plastic; a main core frame coupled to an exterior surface of the main inner skin; a main reinforcing frame coupled to an exterior surface of the main core frame; and a main outer skin coupled to an exterior surface of the main reinforcing frame and made of fiber reinforced plastic, wherein the main inner skin, the main core frame, the main reinforcing frame, and the main outer skin of the main body are formed integrally by molding, and wherein a front surface, a back surface, a left side surface, a right side surface, and an upper surface of each of the main inner skin, the main core frame, the main reinforcing frame, and the main outer skin are formed integrally by molding.

A method of forming the main body according to another exemplary embodiment of the present invention may include: disposing the main outer skin at an interior of a mold frame having a buttress and a molding frame for a molding process; disposing the main reinforcing frame at an interior of the main outer skin; disposing the main core frame at an interior of the main reinforcing frame; disposing the main inner skin at an interior of the main core frame; and forming the main outer skin, the main reinforcing frame, the main core frame, and the main inner skin to be disposed sequentially in the mold frame by vacuum-molding.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a vehicle body according to an exemplary embodiment of the present invention.

FIG. 2 is an exploded view of a vehicle body according to an exemplary embodiment of the present invention.

FIG. 3 is an exploded view of a main body according to an exemplary embodiment of the present invention.

FIG. 4 is an exploded view of a lower body according to an exemplary embodiment of the present invention.

FIG. 5 is a schematic diagram of a molding process for a main body of a vehicle body according to an exemplary embodiment of the present invention.

FIG. 6 is a flowchart of the molding method for a main body of a vehicle body according to an exemplary embodiment of the present invention.

### DESCRIPTION OF SYMBOLS

1: vehicle body
10: mold frame
100: main body
110: main outer skin
120: main reinforcing frame
130: main core frame
140: main inner skin
200: lower body
300: inner body

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of the present invention will be described in detail with reference to the accompanying drawings so as to be easily practiced by a person skilled in the art.

Such exemplary embodiments are exemplary embodiments according to the present invention. Since a person skilled in the art can realize the present invention in various forms of exemplary embodiments, the scope of the present invention is not limited to exemplary embodiments which will be hereinafter described.

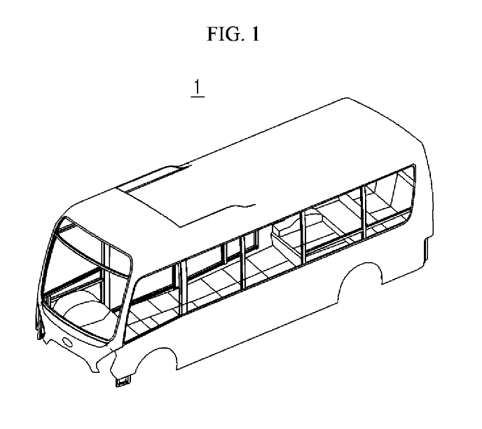

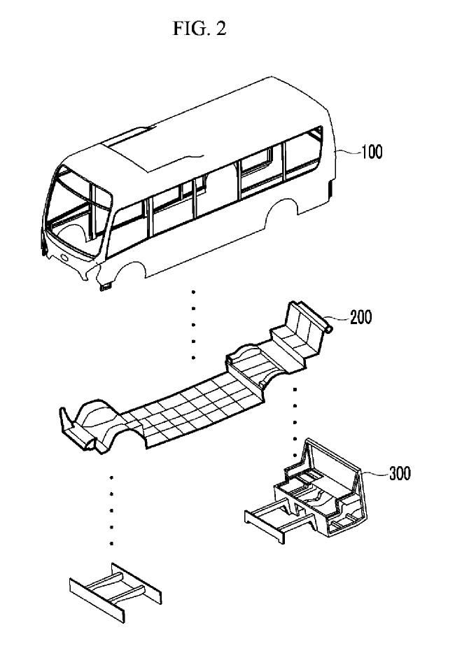

FIG. 1 is a schematic diagram of a vehicle body according to an exemplary embodiment of the present invention, FIG. 2 is an exploded view of a vehicle body according to an exemplary embodiment of the present invention.

Referring to FIG. 1 and FIG. 2, the vehicle body 1 includes a main body 100, a lower body 200, and an inner body 300.

The main body 100 forms an appearance of a vehicle, and a frame forming an outline of the main body 100 is integrally molded with an exterior surface coupled to the frame. The main body 100 is integrally formed with a front surface, a back surface, a left side, a right side, and an upper surface.

The lower body 200 is coupled to a lower portion of the main body 100, and forms a bottom surface, and a frame farming an outline of the low body 200 is integrally molded with the exterior surface coupled to the frame.

The inner body 300 is a structure installed between the main body 100 and the lower body 200, and a frame forming an outline of the inner body 300 is integrally molded with the exterior surface coupled to the frame.

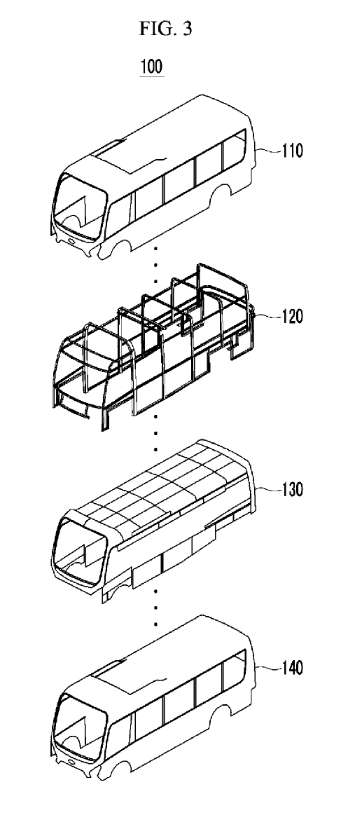

FIG. 3 is an exploded view of a main body according to an exemplary embodiment of the present invention.

Referring to FIG. 3, the main body 100 includes a main outer skin 110, a main reinforcing frame 120, a main core frame 130, and a main inner skin 140.

The main outer skin 110 is an exterior skin layer of the main body 100, and is made of a fiber reinforced plastic (FRP). The fiber reinforced plastic is a resin combining a synthetic resin material with a fiber so as to improve mechanical strength. Therefore, the main outer skin 110 made of the fiber reinforced plastic improves the strength of the vehicle body 1.

The main reinforcing frame 120 is a skeleton of the main body 100, and is formed of the metal material. The metal material may be aluminum or an aluminum alloy. The aluminum or the aluminum alloy is light and has good ductility. Accordingly, the main reinforcing frame 120 reduces the weight of the vehicle body 1, and a force for absorbing an impact and the strength are improved.

The main core frame 130 is a skeleton of the main body 100, and is formed by inserting and molding a thermoplastic plastic to wood. The wood may be a light wood such as balsa, and the thermoplastic plastic may be a polyvinyl chloride which is light and has good strength. Accordingly, the main core frame 130 reduces the weight of the vehicle body 1, and a force for absorbing an impact and the strength are improved. In addition, the main core frame 130 reduces vibration and noise because the main core frame 130 is made of the light wood.

The main inner skin 140 is an interior skin layer of the main body 100, and is made of a fiber reinforced plastic (FRP). Accordingly, the main inner skin 140 improves the strength of the vehicle body 1 the same as the main outer skin 110.

A front surface, a back surface, a left side surface, a right side surface, and an upper surface of each of the main outer skin 110, the main reinforcing frame 120, the main core frame 130, and the main inner skin 140 are formed integrally by molding.

Therefore, such main body 100 is light, and the strength thereof is relatively high. Also, such main body 100 is flexible in response to an exterior impact, and reduces vibration and noise.

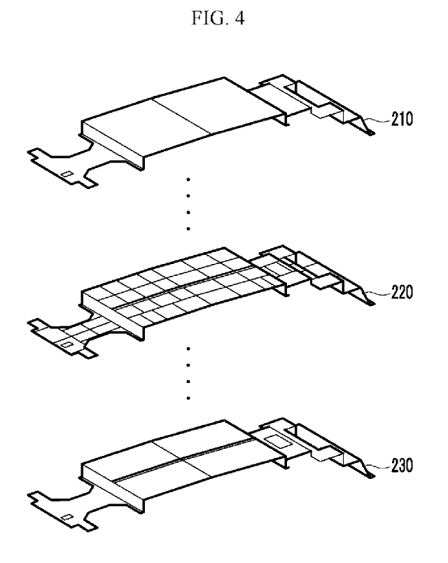

FIG. 4 is an exploded view of a lower body according to an exemplary embodiment of the present invention.

Referring to FIG. 4, the low body 200 includes a lower outer skin 210, a lower frame 220 and a lower inner skin 230.

The lower outer skin 210 and the lower inner skin 230 are respectively an exterior skin layer and an interior skin layer of the lower body 200, and is made of a fiber reinforced plastic (FRP).

The lower frame 220 is a skeleton of the lower body 200, and is formed by inserting and molding a thermoplastic plastic to a metal member.

Therefore, such lower body 200 is light, and the strength thereof is relatively high. Such lower body 200 is flexible in response to an exterior impact, and reduces the vibration and noise, the same as the main body 100.

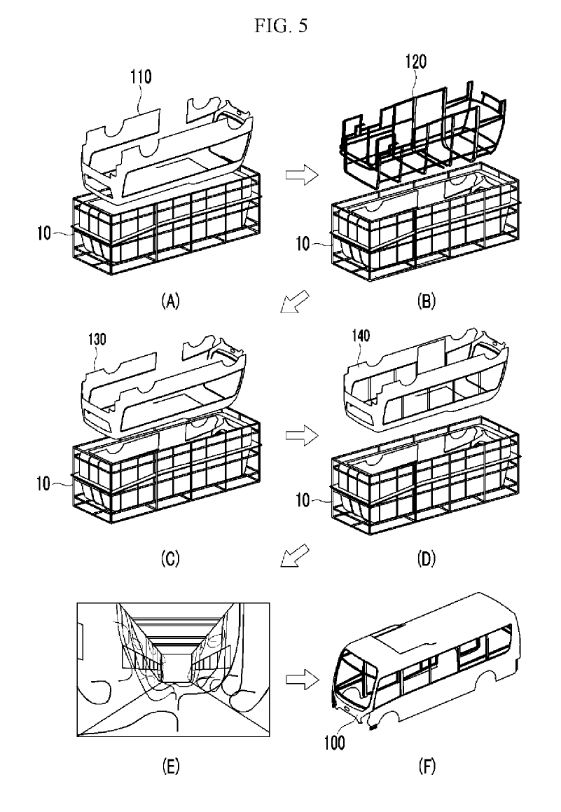

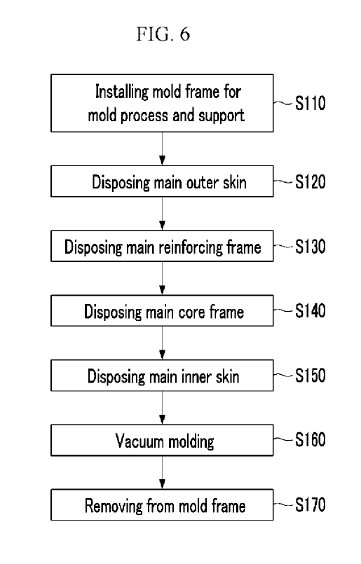

FIG. 5 is a schematic diagram of a molding process for a main body of a vehicle body according to an exemplary embodiment of the present invention, and FIG. 6 is a flowchart of the molding method for a main body of a vehicle body according to an exemplary embodiment of the present invention.

As shown in FIG. 5 and FIG. 6, the main body 100 sequentially includes the main outer skin 110, the main reinforcing frame 120, the main core frame 130, and the main inner skin 140, which are then molded by pressing in a vacuum and heating.

Specifically, when a molding process of the main body 100 is processed, a buttress supporting the main body 100 and a mold frame 10 forming an appearance of the main body 100 are installed as shown in (A) of FIG. 5 and step S110 in FIG. 6

The mold frame 10 is installed such that an interior of the main body 100 face upwards.

The main outer skin 110 is disposed in an interior of the mold frame 10 as shown in (B) of FIG. 5 and step S120 in FIG. 6. The main reinforcing frame 120 is disposed in the interior of the main outer skin 110 as shown in (C) of FIG. 5 and step S130 in FIG. 6. The main core frame 130 is disposed in the interior of the main reinforcing frame 120 as shown in (D) of FIG. 5 and step S140 in FIG. 6. The main inner skin 140 is disposed in the interior of the main core frame 130 as shown in (E) of FIG. 5 and step S150 in FIG. 6.

The main outer skin, the main reinforcing frame, the main core frame, and the main inner skin disposed sequentially in the mold frame are pressed in a vacuum, and then molded by heating as shown in (F) of FIG. 5 and step S160 in FIG. 6. Then, the molded main body 100 is removed from the mold frame 10 at step S170 in FIG. 6.

The method for molding the low body 200 is not illustrated in the drawings, however, is the same as that of the main body 100. That is, the lower outer skin 210, the lower frame 220, and the lower inner skin 230 of the lower body 200 are sequentially disposed in the mold frame 10 including a buttress supporting the lower body 200 and a mold frame 10 formed an appearance of the lower body 200 and then is molded by pressing in a vacuum and heating.

Also, the inner body 300 is molded the same as such method. That is, an outer skin, an inner frame, and an inner skin of the inner body 300 is sequentially disposed, and is then molded by pressing in a vacuum and heating.

Therefore, the vehicle body 1 formed by the main body 100, the low body 200, and the inner body 300 is light, and its strength is relatively high.

According to an exemplary embodiment of the present invention, the assembly process may be simplified and the strength of the vehicle body is improved.

Also, according to an exemplary embodiment of the present invention, the production cost is reduced by simplifying the assembly process, fuel consumption of the vehicle is improved by reducing the weight of the vehicle body, and a degree of freedom for design is increased by being integrally formed.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle body comprising:
a main body providing an outer appearance of a vehicle; and
a lower body forming a bottom surface and coupled to a lower portion of the main body;
wherein the main body comprises:
a main inner skin made of fiber reinforced plastic;
a main core frame coupled to an exterior surface of the main inner skin;
a main reinforcing frame coupled to an exterior surface of the main core frame; and
a main outer skin coupled to an exterior surface of the main reinforcing frame and made of fiber reinforced plastic;
wherein the main inner skin, the main core frame, the main reinforcing frame, and the main outer skin of the main body are formed integrally by molding; and
wherein a front surface, a back surface, a left side surface, a right side surface, and an upper surface of each of the main inner skin, the main core frame, the main reinforcing frame, and the main outer skin are formed integrally by molding.

2. The vehicle body of claim 1, wherein the main reinforcing frame is made of a metal material.

3. The vehicle body of claim 2, wherein the metal material is aluminum or an aluminum alloy.

4. The vehicle body of claim 1, wherein the main core frame is formed by insert-molding a thermoplastic plastic to wood.

5. The vehicle body of claim 1, wherein the lower body comprises:
a lower inner skin made of fiber reinforced plastic;
a lower frame coupled to an exterior surface of the lower inner skin; and
a lower outer skin coupled to an exterior surface of the lower frame and made of fiber reinforced plastic;
wherein the lower inner skin, the lower frame, and the lower outer skin of the lower body are formed integrally by molding.

6. A main body forming an appearance of a vehicle, comprising:
a main inner skin made of fiber reinforced plastic;
a main core frame coupled to an exterior surface of the main inner skin;
a main reinforcing frame coupled to an exterior surface of the main core frame; and
a main outer skin coupled to an exterior surface of the main reinforcing frame and made of fiber reinforced plastic;
wherein the main inner skin, the main core frame, the main reinforcing frame, and the main outer skin of the main body are formed integrally by molding; and
wherein a front surface, a back surface, a left side surface, a right side surface, and an upper surface of each of the main inner skin, the main core frame, the main reinforcing frame, and the main outer skin are formed integrally by molding.

7. A method of forming the main body according to claim 6, comprising:
disposing the main outer skin at an interior of a mold frame having a buttress and a molding frame for a molding process;
disposing the main reinforcing frame at an interior of the main outer skin;
disposing the main core frame at an interior of the main reinforcing frame;
disposing the main inner skin at an interior of the main core frame; and
forming the main outer skin, the main reinforcing frame, the main core frame, and the main inner skin to be disposed sequentially in the mold frame by vacuum-molding.

8. The vehicle body of claim 1, wherein the front surface, the back surface, the left side surface, the right side surface, and the upper surface of at least one of the main inner skin, the main core frame, the main reinforcing frame, and the main outer skin are monolithically formed.
